(19) United States
(12) Patent Application Publication
(10) Pub. No.: US 2017/0235512 A1
(43) Pub. Date: Aug. 17, 2017

(54) CONFIGURATION OF STORAGE USING PROFILES AND TEMPLATES

(71) Applicant: HITACHI, LTD., Tokyo (JP)

(72) Inventors: Arora RUCHITA, Bellevue, WA (US); Utkarsh SHAH, Bellevue, WA (US); Gaurav BORA, Bellevue, WA (US); Ankur KASTURIYA, Bellevue, WA (US)

(21) Appl. No.: 15/502,647

(22) PCT Filed: Dec. 11, 2014
(86) PCT No.: PCT/US2014/069813

§ 371 Date: Feb. 8, 2017

(51) Int. Cl. G06F 3/06

(52) U.S. Cl. CPC G06F 3/0632; G06F 3/0604; G06F 3/067

(57) ABSTRACT

The systems and methods described in this present disclosure are directed to template based deployment for the initial configuration of infrastructure. Templates can be created and applied to a new resource to create resource profiles. Whenever profiles are created, the templates can be optimized for the new resource by applying the rules in the template to the existing configuration of the new resource. Additionally, the present disclosure also focuses on the application of user-defined preferred practices to automate individual steps involved in setup and configuration of storage system setup when a storage template is applied.

### BACKGROUND

Field

The present disclosure relates generally to storage systems, and more specifically, to configuration of storage systems by utilizing storage profiles.

Related Art

The initial setup and configuration of a related art storage system can be time consuming and complex. Configuration of a related art storage system can require exhaustive knowledge of the storage array technology as well as lot of pre-planning to setup the storage system for intended use. In the related art, the configuration of the storage system may involve the user manually mapping out the planned use of the storage array against the availability of licenses and availability of the type, size and count of disks in the storage system again. Once the storage system is set up, the engineers utilizing related art implementations manually create parity groups using multiple disks, pools using existing parity groups and manual selection of World Wide Names (WWNS) on the storage system and one or more servers to allocate storage to a server. More specifically, WWNS refers to World Wide Port Names (WWPN).

A similar effort is repeated manually in related art implementations when storage capacity is expanded, new disks are added and/or storage is provisioned to a server for consumption.

Multiple problems associated with the related art methods occur for the configuration of a storage system. For example, the manual setup of every storage system requires planning by taking into account the use of storage system, available licenses, disks and customers environment settings. The setting up of parity groups and pools requires understanding of storage technology for manual implementation. Provisioning storage to a server requires the users to manually select the world wide names (WWNS) on the storage system and the server to create zones, resulting in complex error prone zoning operations.

Because of the above mentioned related art problems, a technical engineer has to set up the storage system and manually implement when the storage box is initially installed as well as every time the storage system is expanded and consumed.

### SUMMARY

Example implementations described herein are related to simplifying the configuration of a storage system by automatically identifying the initial settings of the system and setting up a storage profile with parity groups, storage pools, volumes and fibre-channel zoning. This present disclosure is targeted to two main scenarios: the first time initial setup and configuration of a storage system; and the ongoing configuration changes and provisioning needs to use and consume storage.

Aspects of the present disclosure include a method for configuring a storage system, which can involve creating a storage profile for the storage system by incorporating one or more configuration policies from a storage template associated with another storage system; based on configuration information of the storage system and storage identity information of the storage system, deriving configuration settings of the storage system from the storage profile; incorporating the derived configuration settings into the storage profile, and applying the storage profile to configure the storage system.

Aspects of the present disclosure further include a management computer communicatively coupled to a storage system, having a memory configured to store a storage template associated with another storage system; and a processor. The processor can be configured to create a storage profile for the storage system by incorporating one or more configuration policies from the storage template associated with another storage system; based on configuration information of the storage system and storage identity information of the storage system, derive configuration settings of the storage system from the storage profile; incorporate the derived configuration settings into the storage profile, and apply the storage profile to configure the storage system.

Aspects of the present disclosure further include a computer program for configuring a storage system, storing instructions for executing a process. The process can involve creating a storage profile for the storage system by incorporating one or more configuration policies from a storage template associated with another storage system; based on configuration information of the storage system and storage identity information of the storage system, deriving configuration settings of the storage system from the storage profile; incorporating the derived configuration settings into the storage profile, and applying the storage profile to configure the storage system. The computer program may be stored on a non-transitory computer readable medium and executed by one or more processors.

### BRIEF DESCRIPTION OF DRAWINGS

FIG. 1A illustrates an overview of the storage architecture, in accordance with an example implementation.

FIG. 1B illustrates an example system, in accordance with an example implementation.

FIG. 2A illustrates a flow diagram for a server, in accordance with an example implementation:

FIG. 2B illustrates extraction of storage templates to form a profile, in accordance with an example implementation:

FIG. 3 illustrates a flow diagram for policy based configuration setting of a storage system, in accordance with an example implementation.

FIG. 4 illustrates an example storage template and profile utilized across multiple systems, in accordance with an example implementation.

FIG. 5 illustrates an example storage template, in accordance with an example implementation.

FIG. 6 illustrates an example storage profile, in accordance with an example implementation.

FIG. 7 illustrates the application of a storage profile in a final configuration, in accordance with an example implementation.

FIG. 8A illustrates a flow diagram for extracting a storage template, in accordance with an example implementation.

FIG. 8B illustrates a flow diagram to apply and utilize a storage template to create one or more storage profiles, in accordance with an example implementation.

FIGS. 9A and 9B illustrate a parity group creation flowchart, in accordance with an example implementation.

FIGS. 10A and 10B illustrate a pool creation flowchart, in accordance with an example implementation.

FIG. 11 illustrates a volume creation flowchart, in accordance with an example implementation.

FIGS. 12A and 12B illustrate an attach volume and auto zoning flowchart, in accordance with an example implementation.

FIG. 13 illustrates a flow diagram for cache management, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

In the related art, the use of Server Profiles provides a concept of extracting certain settings of an existing resource and applying to a new resource. The present disclosure is directed to the expansion of the use of server profiles in several ways. For example, example implementations as described herein focus on conducting a smart extract when creating a template from an existing resource, i.e., it focuses not on the actual values of every setting and parameter but on extracting rules used in the existing resource. Example implementations described herein are also directed to optimizing the profile based on the configuration of the new resource. So when the rules from a template are applied to a new resource, the algorithm takes the variables of the new resource into account in example implementations.

In the related art, automatic zoning of storage volumes to a server can be implemented. The present disclosure expands on such implementations by incorporating additional implementations. For example, example implementations described herein facilitate automatic zoning in an unknown environment. The algorithm described here first discovers the datacenter environment including the server, fibre-channel switches, storage systems and any existing zone sets and takes each of these data points into account before setting up any new auto zones between storage system and the server. Example implementations further utilize zoning policies based on storage templates and profiles. The storage provisioning algorithm with auto zoning, described in the present disclosure also utilizes storage templates to define zoning policies. These policies or rules determine the number of zone sets that should be provisioned to setup the required number of paths between the server and the storage system.

Example implementations of the present disclosure incorporate various areas of setup, configuration and provisioning of storage. Those areas can include the use of storage templates to mirror and optimize the configuration of one or more storage system based on capacity and performance requirements, the automatic configuration of parity groups by configuring hot spare disks, RAID layouts and physical volumes (e.g. logical devices or LDEVs), the automatic creation of storage pools using the right parity groups, and creating one or more volumes and attaching them to one or more servers by providing automatic fibre-channel zoning based on rules defined in the storage template. Each of the above mentioned areas can help make the storage configuration process repeatable and self-serviceable.

In example implementations, a storage system can be initialized and configured by extracting and applying the storage configuration rules and policies used in an existing storage system. This can take away the guess work required to setup the storage system which may have otherwise required detail technical analysis of the storage system to decide the storage settings and rules such as system options and settings, audit settings, Redundant Array of Inexpensive Disks (RAID) configuration, cache management, storage pool formation, zoning rules, and so on.

In example implementations, user defined preferred practices can be implemented within the storage system or the system as general policies, and can include settings that the user may consider to be the best practice for a particular storage system. Such user defined preferred practices can be implemented as default settings for the storage system, for example, in situations where the storage template or profile does not specify the policy or configuration for the storage system. The user defined preferred practices can include, for example, default cache allocation percentages, parity group creation percentages, zoning policies, and so on, but are not limited thereto. Each example implementation described herein can incorporate the user defined preferred practices as a general default.

In example implementations, the automatic configuration of parity groups is utilized to automate and simplify the setup regardless of whether the storage system was initialized and configured beforehand. With the automatic creation of parity groups, the total raw capacity of a storage system is transformed into net usable capacity.

In example implementations, the automatic creation of storage pools can be implemented as a one-time configuration activity that is used to decide how storage capacity can be allocated based on intended use of the storage system and available performance tiers. With respect to pool creation, example implementations can be directed to detecting the type of licenses available to create storage pools that can support dynamic provisioning and thin image provisioning, as well as the type of parity groups available in the storage system to determine and present the types and sizes of pools that can be created. The capability discussed as a part of this step can be used regardless of whether pools are created as a part of the initialization of the storage system with the storage profile.

In example implementations, there is the automatic provisioning of storage to a server by carving out the requested block storage volumes and then creating and assigning appropriate zones between the requested server and storage. Example implementations utilize the discovering of the fiber channel environment, detecting existing zone paths, if any, and selecting the world wide names to provide load balancing between the initiator and target ports. Similar to the above implementations, the recommended algorithm can be used regardless of whether zoning policies are included as a part of the initialization of the storage system.

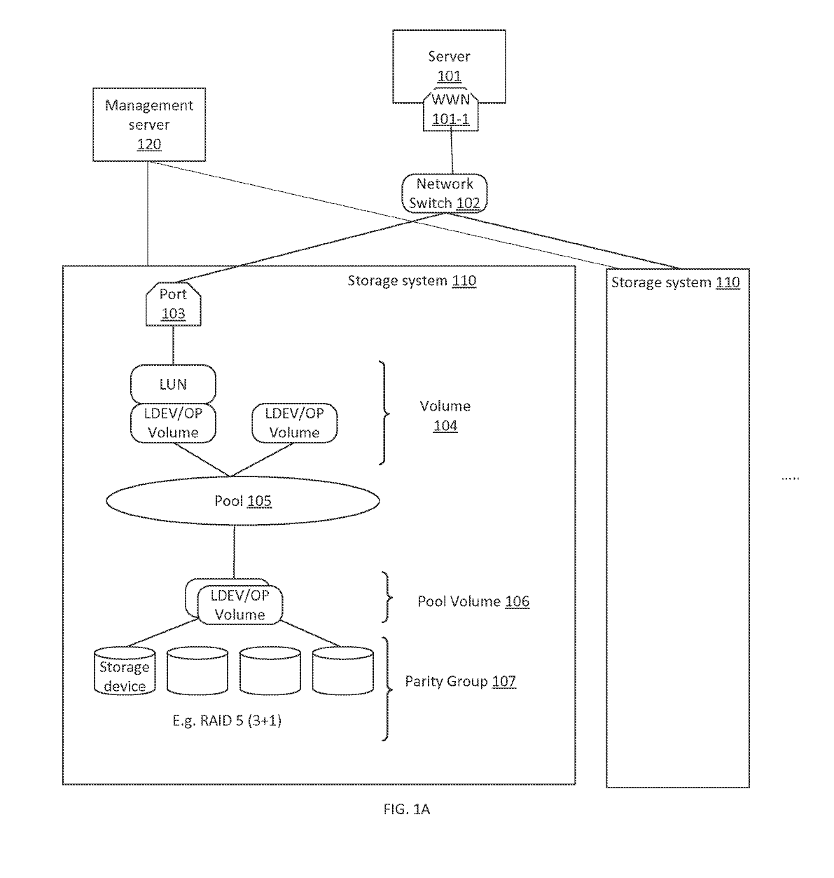

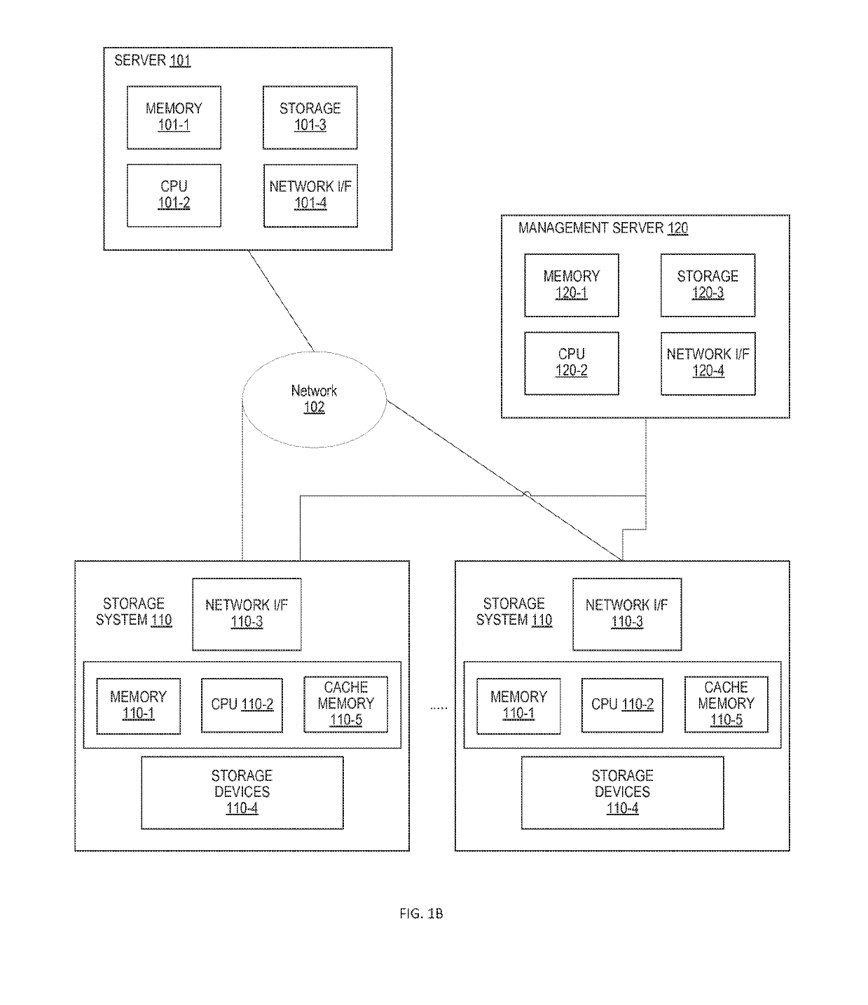

FIG. 1A illustrates an overview of the architecture, in accordance with an example implementation. Computer system may have a server 101 with a WWN 101-1 to facilitate connections to the network, one or more network switches 102, a management server 120, and one or more storage systems 110. The Storage system 110 includes one or more associated ports 103, and one or more volumes 104 which can be associated with Logical Unit Numbers (LUN) and be composed of one or more LDEVS (Logical DEVice). The one or more volumes 104 can form a pool 105. Each of the pool volumes 106 is associated with parity group information 107 to indicate RAID status.

When a new storage system 110 is configured, the setup begins at the lowest entity, i.e, creating parity groups by using one or more disks. The next step is to create volumes (e.g., physical volumes, pool volumes) on the parity groups, add one or more volumes (e.g., physical volumes, pool volumes) to create a pool, Once the pool is created, the next step is to create volumes (e.g., virtual volumes) on the pool, wherein the virtual volumes are provided with logical unit number to the server. When storage is consumed (i.e., provisioned to a server), one or more paths need to be setup between the server and the storage system and the storage volume should be presented on these paths.

FIG. 1B illustrates an example system, in accordance with an example implementation. Specifically, FIG. 1B illustrates hardware configuration of the elements that make up the storage architecture of FIG. 1A. Such hardware implementations can include the server 101, the network 102, one or more storage systems 110.

Server 101 may include a memory 101-1, a central processing unit (CPU) 101-2, storage 101-3 and Network interface (I/F) 101-4. Storage 101-3 may be utilized to manage one or more application programming interfaces (APIs) as described herein, which can be loaded into memory 101-1 and executed by CPU 101-2. Network I/F 101-4 is configured to interface with network 102.

Management Server 120 may include a memory 120-1, a central processing unit (CPU) 120-2, storage 120-3 and Network interface (I/F) 120-4. Storage 120-3 may be utilized to manage one or more application programming interfaces (APIs) as described herein, which can be loaded into memory 120-1 and executed by CPU 120-2 in the case that the management server acts as a management computer. The CPU 120-2 performs one or more of the flow diagrams as described herein. The management server 120 may function as a management computer for extracting a storage template from one of the storage systems 110, extracting a storage identity of another one of storage system 110 (e.g., hardware configuration, license for each function), creating a storage profile based on the storage template and storage identity, and configuring the another one of the storage system 110 with the created storage profile by applying the storage profile to the another one of the storage system. The storage system may then utilize the storage profile to implement the example implementations described herein.

The volumes 104 composing the pool 105 are generated from one or more storage systems 110. Storage system 110 may include memory 110-1, CPU 110-2, network I/F 110-3, a cache memory 110-5, and one or more storage devices 110-4 (disks). The memory 110-1, the CPU 110-2, and the cache memory 110-5 can be included in a storage controller. The memory 110-1 may store programs of storage function, and the CPU 110-2 performs operations or instructions associated with the programs stored in the memory to utilize the storage function. The Network I/F 110-3 is configured to interact with the network 102 to interact with server 101 and/or other storage systems to obtain the desired storage profile or to provide the desired storage template. The cache memory 110-5 temporarily stores data corresponding read/write request to accelerate response time to the request from a server. One or more storage devices 110-4 provide the capacity for forming one or more storage volumes which can be incorporated into the pool as illustrated in FIG. 1A.

In example implementations, there are two aspects including the initialization of the storage system and the extraction of the storage template from the storage system. The initialization process utilizes management software to be running on a management server which can either be a physical server or a virtual machine. Then, the storage system is added to the management software. Once the storage system has been added to the management software, the storage system is initialized.

The initialization of a storage system involves the following processes: applying the network settings and licenses; applying Firmware, Date Time, Audit Setting; and creating Parity Groups, Pools and Volumes. Each of these processes expands into multiple processes and can be a long-running task. In each of the processes above, user defined preferred practices are applied for the optimization of the storage system. Once all the above operations are completed successfully, the storage system is ready for use.

Some of the possible user defined preferred practices applied for the initialization and setup of the first storage system are provided as examples in the parity group creation, pool creation, and create/attach volume to a server implementations as described herein. These example implementations describe example user defined preferred practices that can be applied for initialization of the first storage system as well as template based configuration of any subsequent storage system.

When one of the storage systems is completely initialized and ready to use as explained above, its configuration can be extracted to create a template (e.g., a storage template). The storage template contains “rules (e.g., policies)” that define the configuration of several components in the source storage system. The plurality of rules are defined for each components in storage systems (e.g., a network interface, a cache memory, storage devices) These rules can be applied on one or more storage systems to create storage profiles for another storage system.

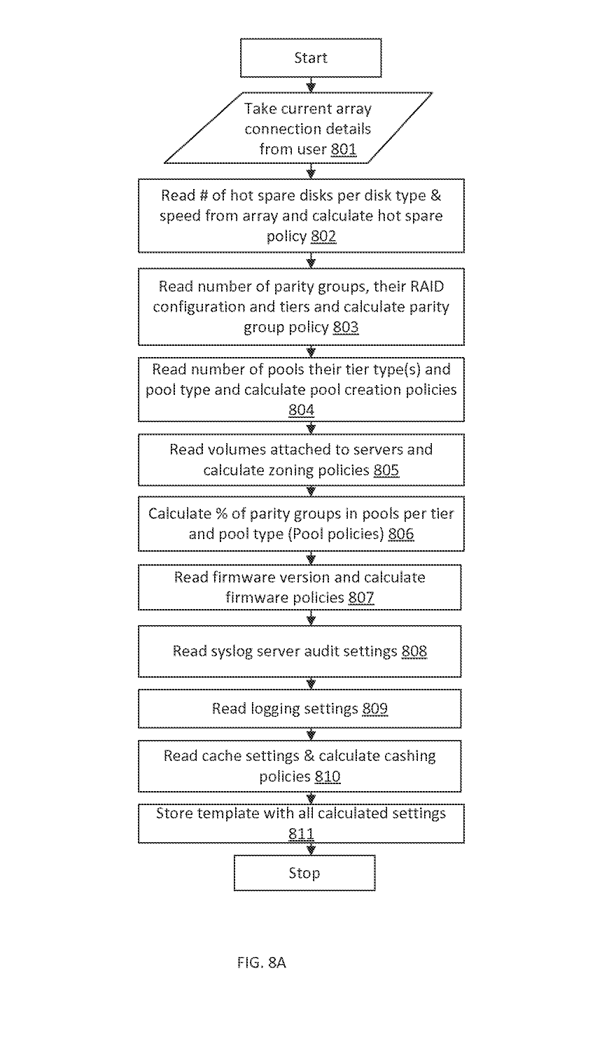

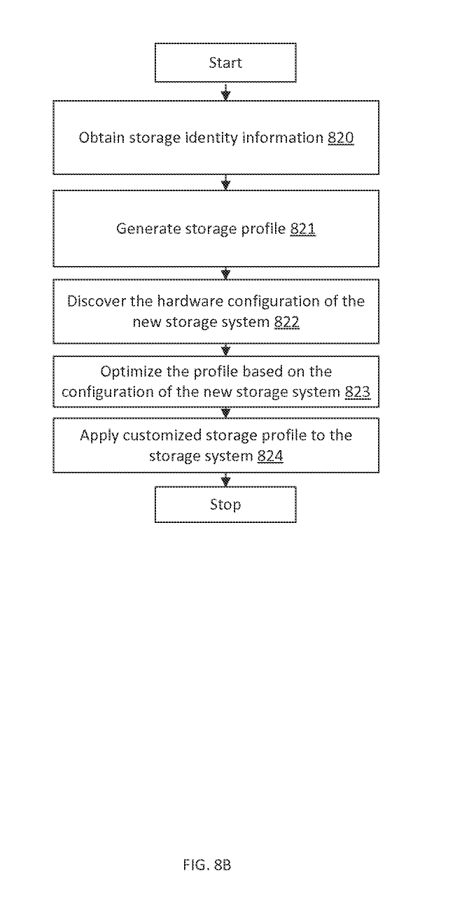

The process of extracting a Storage Template from a Storage System involves the following processes: discover the Storage System for its settings and configurations; select the settings, configurations and rules to be captured in the template; create a Template with generic settings common across multiple Storage Systems. The process of extracting the Storage Template will be explained more specifically in FIG. 8A.

The use of storage templates can provide the ability to extract the existing rules and policies used to configure a known storage system and apply them to configure one or more new storage systems. The storage templates can be utilized with the storage identity of the new storage system as well as the existing configuration of the new storage system to apply the storage template, optimize any roles or policies for the new storage system and create a unique storage profile for the new storage system. This use of storage templates can help in making the process repeatable for multiple storage systems.

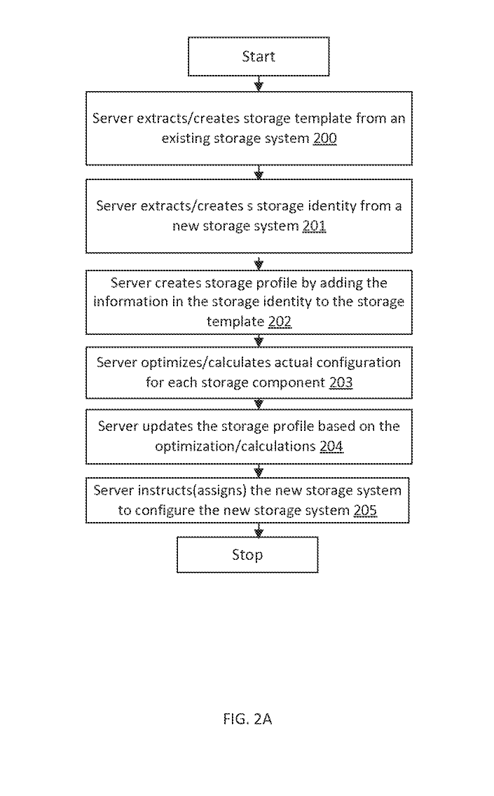

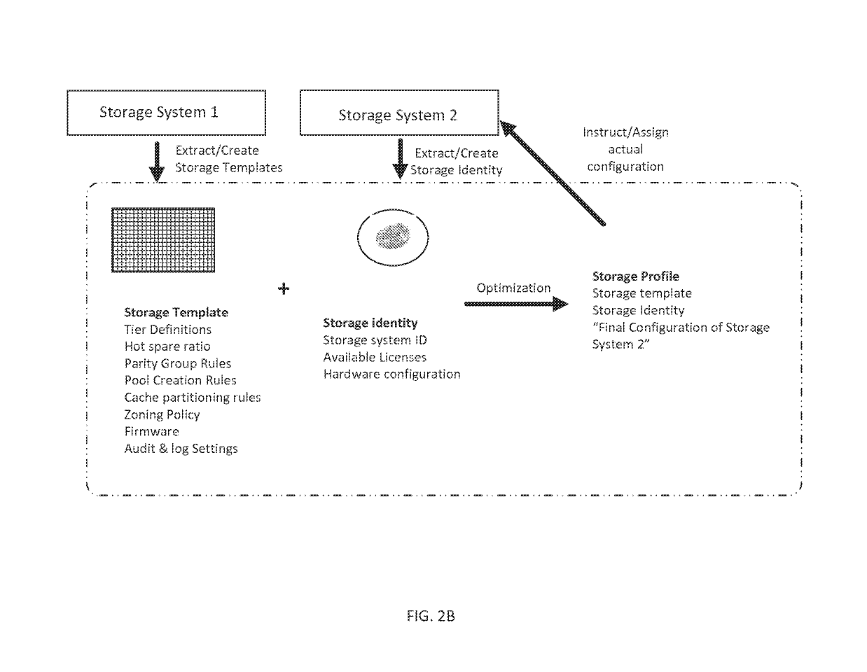

FIG. 2A illustrates an example flow diagram for a management server, in accordance with an example implementation. The management server is configured as a management computer to manage one or more storage systems.

At 200, the management server extracts/creates storage template from an existing storage system. The storage template includes one or more policies for each storage component (e.g. a network interface, a cache memory, storage devices, etc.). In another example implementation, the storage template can be manually input by administrator through input device of the management server. At 201, the management server extracts/creates the storage identity from a new storage system (e.g., the storage system to be configured). In another example implementation, the storage identity can be manually input by administrator through input device of the management server. The storage identity information includes license information for using various storage functions and the hardware configuration for each storage component.

At 202, the management server creates the storage profile by combining the information from the storage identity to the storage template. At 203, the management server optimizes/calculates the configuration for each storage component of the new storage system by utilizing the policy in the storage template, the available licenses and the hardware configuration from the storage identity. At 204, the management server updates the storage profile based on the optimization/calculations. At 205, the management server instructs or assigns the new storage system to configure the new storage system based on configuration in the updated storage profile. Before operation 205, the management computer can confirm approval from an administrator by displaying actual configuration of the new storage system.

FIG. 2B illustrates processes executed by the management server as described in FIG. 2A. A storage system 1 is a storage system which has been already configured (e.g., an existing storage system). A storage system 2 is a storage system which is to be configured (e.g., a new storage system). The management server extracts and creates the storage templates to form a storage profile, in accordance with an example implementation, FIG. 2B also illustrates the contents of a storage template. As illustrated in FIG. 2B, the storage template can include the following rules/policies.

Tier Definition information for the disk type. Examples of tiers can include Platinum, Gold, Silver, Bronze, and so on, based on the disk type, the disk speed and the disk capacity of the storage devices of the storage system.

Hot spare allocation ratios, which indicates the percentage of the disk reserved as hot spares.

Parity group information, which includes parity group creation policies to optimize for performance/capacity/resiliency.

Pool creation information, including pool creation policies to define pool tiering ratios and data protection pool requirements.

Zoning information including zoning policies to indicate the number of paths and number of fabrics for the storage system.

Firmware version to indicate the minimum or maximum version number.

Audit settings for the internet protocol (IP) of the syslog server.

Log settings which include debug log requirements.

Caching information including cache partitions that indicates the percentage of cache allocated for different requirements.

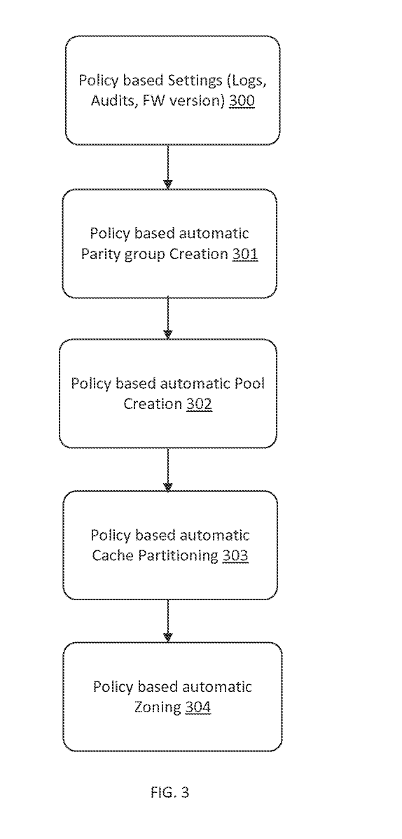

The management server also extracts and creates a storage identity which is particular information for the storage system 2. The storage identity includes information such as available licenses within the storage system 2, storage system identification information, and the hardware configuration of the storage system 2. The management server creates a storage profile based on the storage template of the storage system 1 and the storage identity of the storage system 2, and assigns the final configuration to the storage system 2. FIG. 3 illustrates an example of flow diagram for policy based configuration setting of a storage system.

As illustrated in FIG. 3, at 300, the management server creates basic setting (Logs, Audits, FW version) based on the policy of the storage template and the storage identity and store the created setting in the storage profile. At 301, the management server executes automatic parity group creation based on the policy of the storage template and the storage identity, and store the created parity group configuration in the storage profile. At 302, the management server executes automatic pool creation based on the policy of the storage template and the storage identity, and stores the created pool in the storage profile. At 303, the management server executes automatic cache partitioning based on the policy of the storage template and the storage identity, and store the created cache partitioning creation in the storage profile. At 304, the management server executes automatic zoning based on the policy of the storage template and the storage identity.

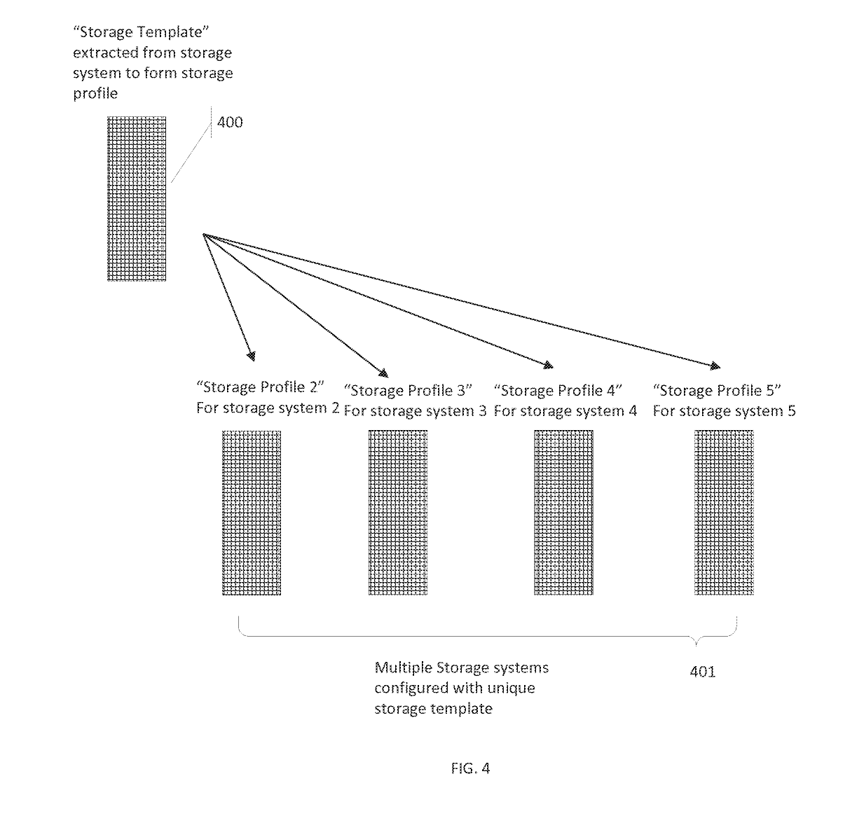

FIG. 4 illustrates an example storage template and profile utilized across multiple storage systems, in accordance with an example implementation. As illustrated in FIG. 4, a single storage template 400 can be used to setup multiple profiles 401. Each storage profile considers storage identity of each storage system. In a datacenter, the administrators can use a single storage template to setup the entire datacenter.

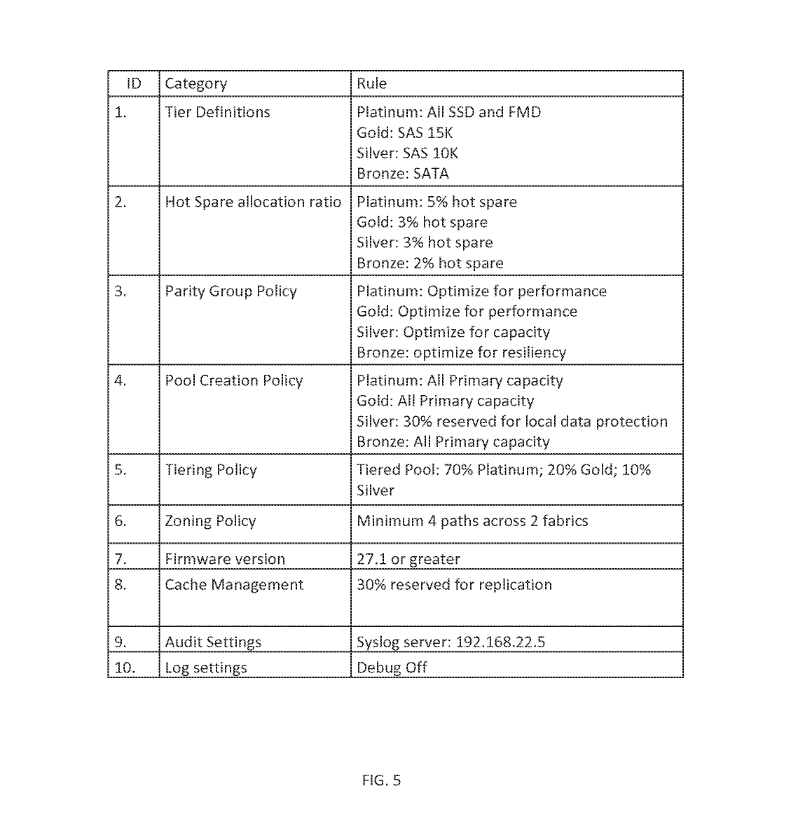

FIG. 5 illustrates an example storage template, in accordance with an example implementation. As illustrated in FIG. 5, there are various rules and policies that can be included as a part of a storage template as described in the implementation of FIG. 2B.

In the example of FIG. 5, the rules and policies of FIG. 2B are applied against tiers as defined in the storage template. Each of the fields affected by tiers are explained below:

Tier Definitions: Depending on the type of storage utilized, the storage devices can be partitioned into tiers provided that tier partitioning licenses are available. In the example of FIG. 5, the storage devices are separated into Platinum, Gold, Silver and Bronze tier. Platinum tier is defined as the Solid State Drive (SSD) and Flash Media Disk (FMD), Gold is defined as Serial Attached Small Computer System Interface (SAS) drives with 15 k revolutions per minute (RPM) capability, Silver is defined as SAS drives with 15 k RPM capability, and Bronze is defined as Serial ATA (SATA) drives.

Hot spare allocation ratios which indicate the percentage of the disk reserved as hot spares for each tier. In the example of FIG. 5, platinum tier have 5% of the disk reserved as hot spare, gold tier has 3% reserved as hot spare, silver tier has 3% reserved as hot spare, and bronze has 2% reserved as hot spare.

Parity group information which includes parity group creation policies to optimize for performance/capacity/resiliency for each tier. In the example of FIG. 5, platinum tier is optimize for performance (e.g., fewer drives are utilized for duplicates in RAID configuration), gold tier is optimize for performance, silver tier is optimize for capacity (e.g., balance between drives used for duplicates in RAID configuration), bronze tier is optimize for resiliency (e.g., more drives are utilized for duplicates in RAID configuration).

Pool creation information including pool creation policies to define pool tiering ratios and data protection pool requirements. In the non-limiting example of FIG. 5, platinum tier, gold tier and bronze tier utilize all primary capacity, whereas silver tier may have 30% reserved for local data protection.

Tiering information including tiering policies for the pool. In the example of FIG. 5, a tiered pool has 70% platinum, 20% gold and 10% silver allocated to the pool.

Cache management information including a cache area replication policy. Additionally, the storage template can include cache partitioning policy to each tenant (logically partitioned storage system).

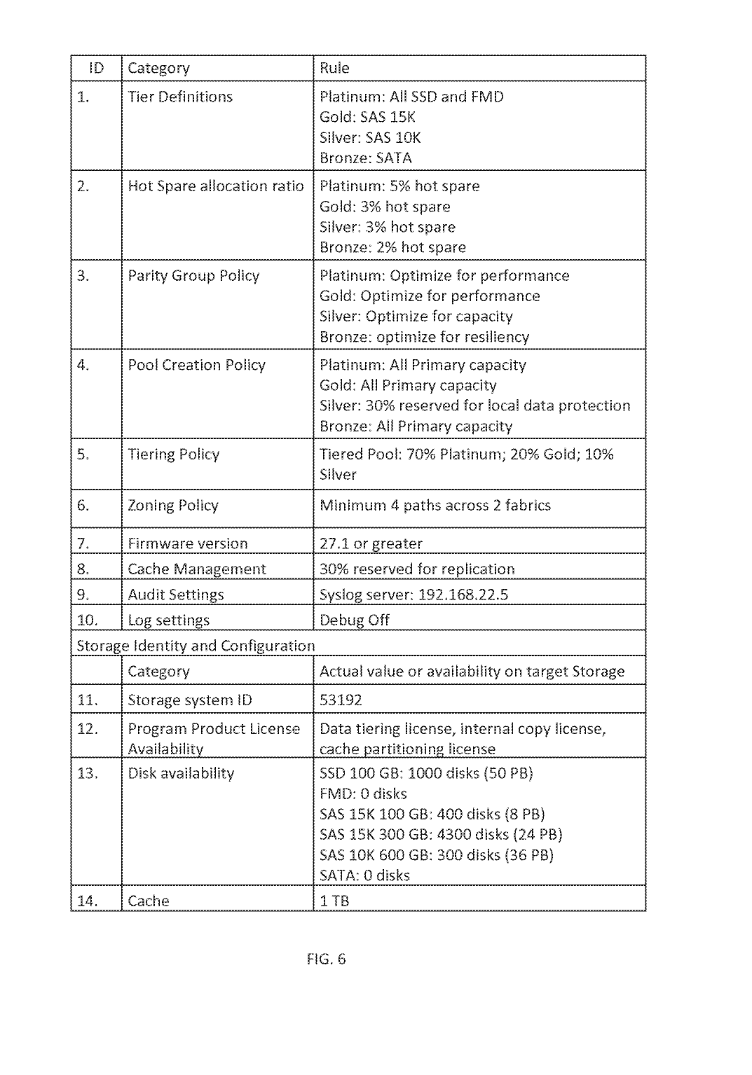

FIG. 6 illustrates an example storage profile, in accordance with an example implementation. Specifically, FIG. 6 illustrates how storage identity information of a new (target) storage system is included along with the template information to create a storage profile. Information from the storage template of FIG. 5 is incorporated into the storage profile along with storage identity information which can include storage system identifier information, available licenses for programs or products, cache availability, and disk availability.

In the example of FIG. 6, storage identity information is provided as follows:

Storage system ID indicates the identifier of the storage system to be configured by the storage profile.

Program product license availability indicates the available licenses for the storage function in the storage system to be configured by the storage profile. If the license for given storage function is available in the storage identity, the storage system can utilize the given storage function.

Disk availability indicates the available disks of the storage system to be configured by the storage profile. Disk availability can be used to determine what tiers are available for application.

Cache indicates the total storage capacity of the cache of the storage system to be configured by the storage system.

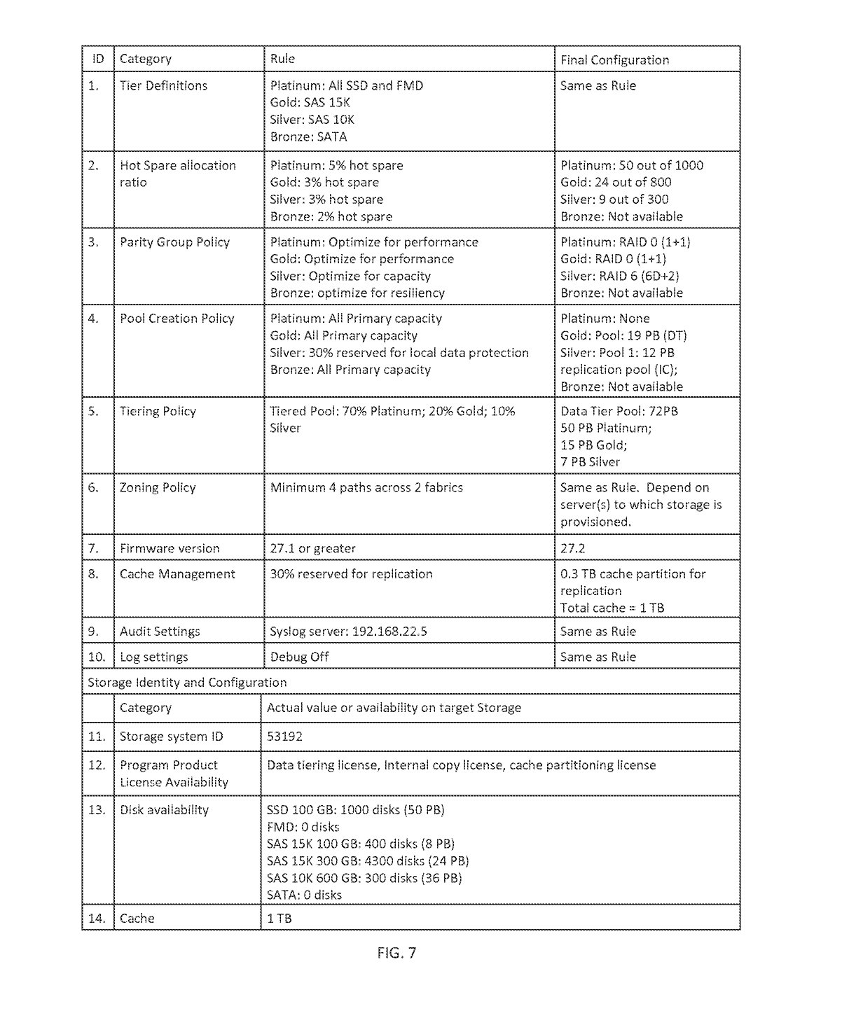

FIG. 7 illustrates optimized storage profile which includes a final configuration, in accordance with an example implementation. Specifically, FIG. 7 illustrates how the rules in a storage profile get translated into the actual final configuration of a storage system based on license availability and hardware configuration of the target storage system. The examples for the final configuration for FIG. 7 are as follows:

Hot spare disks are calculated based on the suggested ratio and the number of disks available on the new storage system. In the example of FIG. 7, hot spares are calculated based on availability of each tier as defined in tier definitions due to the availability of the data tiering license.

Parity group creation: The RAID configuration and layout are selected based on template policy and the number of disks available in the new storage system. In the example of FIG. 7, as platinum and gold tier are optimized for performance, the configuration is set to RAID 0 with one parity disk utilized. Silver tier is optimized for capacity with a RAID 6 configuration having two parity disks.

Pool creation: The tiering policy is used to define the sizes of each tier in the pool. The remaining capacity of each tier is then carved out into individual pools. Additionally, due to availability of the internal copy license, the silver tier is used to create a silver tier pool based on the policy to reserve 30% capacity for data protection and remaining capacity is allocated to a silver tier pool in FIG. 7. If the storage system does not have the corresponding license, the management server does not allocate the 30% capacity of secondary pool of local data protection. Further, due to the availability of the data tiering license, Gold tier is sized as 19 PB. Similarly, due to the internal copy license, Silver tier is created as a 12 PB replication pool.

Tiering policy: Due to the availability of the data tiering license, the tiering policy defines the storage tier utilized for each pool and is calculated according to the provided percentages in the storage profile from the storage identity information. If the storage system does not have the corresponding license, the management server does not configure the tiering pool.

Zoning policy: Same as rule. Actual number of zones created will depend not only on storage configuration but also on the server to which storage is provisioned.

Cache partition: Cache is reserved for replication requirements as defined in the storage profile.

Audit and log settings: Same as rule in the storage profile.

FIG. 8A illustrates a flow diagram for extracting a storage template, in accordance with an example implementation. Specifically, FIG. 8A illustrates how the management server extracts information from a storage system (e.g. already configured storage system) to create a storage template. When one of the storage systems is completely initialized and ready to use as explained above, its configuration can be extracted to create a template.

At 801, the management server obtains current storage systems connection details from user. At 802, the management server reads the number of hot spare disks per disk type and the speed from the storage system and calculates the hot spare policy for each tier. At 803, the management server reads number of parity groups, the RAID configuration and tiers from the storage system and defines the parity group policy for each tier. At 804, the management server reads the number of pools, their tier type(s) and pool type from the storage system and calculates pool creation policies for each tier. At 805, the management server reads the volumes attached to management servers from the storage system and calculates the zoning policies. At 806, the management server calculates the percentage of parity groups in the pools per tier and pool type to form pool policies. At 807, the management server reads the firmware version from the storage system and defines firmware policies. At 808, the management server reads syslog server audit settings from the storage system. At 809, the management server reads the logging settings from the storage system. At 810, the management server reads cache settings and calculates cashing policies. At 811, the management server creates a storage template and incorporates all of the calculated and read settings.

FIG. 8B illustrates a flow diagram to apply and utilize a storage template to create one or more storage profiles, in accordance with an example implementation. When a new storage system needs to initialized, the configured and provisioned storage template created from FIG. 8A is deployed or applied. Deploying a storage template to the new storage system involves the following flow.

At 820, the management server or management computer obtains storage identity information from the prospective new storage system, which includes storage system instance specific identity details. This can include the storage system ID and available licenses on the new storage system and hardware configuration of each component of the new storage system. At 821, the management server creates a storage profile from the storage template obtained from another storage system, and the storage identity information from the new storage system. That is, for the new storage system, the management server combines the storage template and storage identity information to create a storage profile. At 822, the management server discovers licenses and the hardware configuration of the new storage system, which can include the various types of disks (disk type, disk speed, disk capacities) and count of each disk type, and cache capacity.

At 823, the management server optimizes the profile based on the license and hardware configuration of the new storage system. That is, based on the hardware configuration and storage profile (storage licenses) of the new storage system, the management server determines if the rules in the template are applicable. For example, if a needed pool creation license is not available on new storage system, a pool creation policy for reserving 30% capacity for data protection pool cannot be applied to the new storage system. In such cases, the storage system notifies the user of any conflicts. The user may choose a different template or override the conflict to continue using the selected template.

At 824, the management server applies the customized profile on the new storage system: Based on the policies in the storage profile, the management server proceeds with configuring the storage system by updating settings for audits and logs, updating the firmware version, if needed, setting hot spare disks and proceeding to create parity groups on the entire array, creating one or more pools based on the profile, and updating cache partitions based on storage profile. With these configurations, the storage system is ready for use. When the user requests to provision storage to a server, the management server can thereby create automatic zones based on number of paths needed across one or more fabrics (as defined in the storage profile).

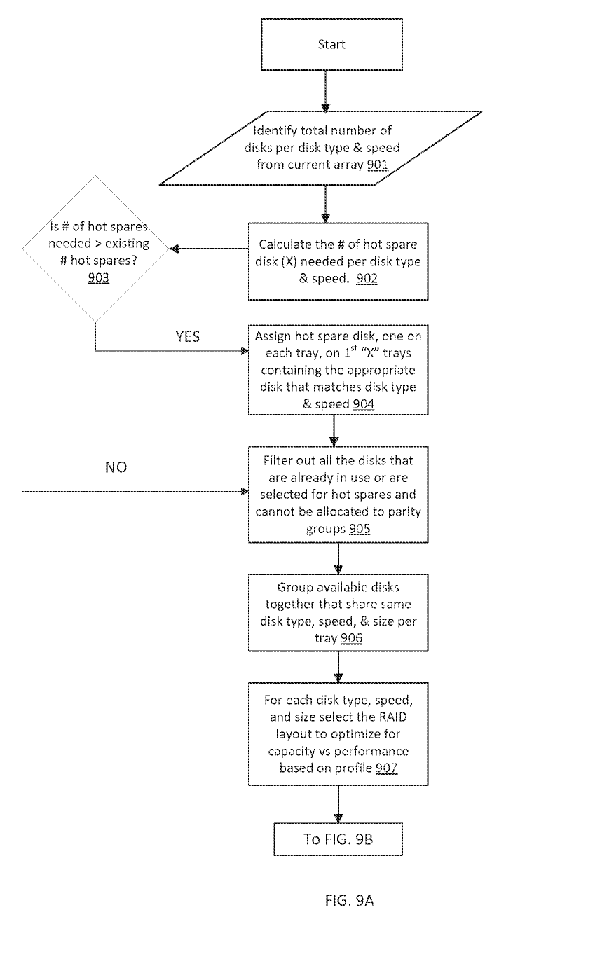

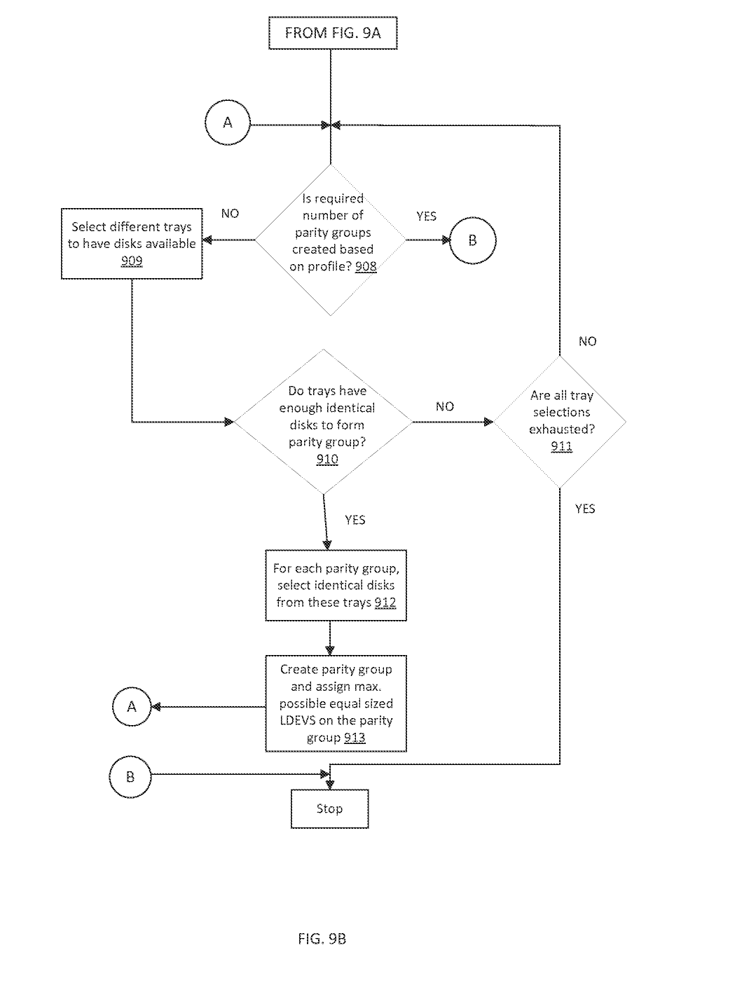

FIGS. 9A and 9B illustrate a parity group creation flowchart, in accordance with an example implementation. Specifically, FIGS. 9A and 9B illustrate how parity groups can be created automatically based on either rules in the storage profile or default preferred user practices.

Automatic Parity group configuration uses an algorithm that applies preferred user policies at every step to automate each step involved in creating parity groups on a storage system. These rules or policies can be derived from the base template used to create a storage profile. When a storage profile is created, the parity group creation policies can also be optimized based on the configuration of the new storage system.

Creating a parity group can include several decisions, each of which is dictated by a user preferred implementation. One decision includes the hot spare disk, which includes the ratio of hot spare disks per disk type and selection of hot spare disks. Another decision can include the RAID configuration and layout to incorporate the user preferred RAID configuration and number of disks per disk type and model. Another decision can include disk selection, which involves selecting disks to create an individual parity group. Another decision can include the LDEV creation, wherein volumes (LDEVS) are created on parity groups which can be used as pool volumes for dynamic provisioning pools.

From the above decisions, further optimization can be implemented based on the number of disks available in the new storage system. An example implementation for auto creating parity groups is described below.

Hot spare disk: In an example implementation, if the management server calculates number of hot spare disks without policy of the storage template, the number of hot spare disks is calculated by using a fixed percentage of the total number of disks in the storage system. This percentage can be different based on different disk types. Regardless of the size and the speed of the disk, a fixed percentage can be defined for different disk types that can be applied for creating hot spare disks.

If the management server calculates number of hot spare disks with policy in the storage template, storage templates can be utilized for the hot spare ratio. For example, the hot spare ratio can be a policy driven ratio since the ratio might not change from one storage array to another. The hot spare ratio for each disk type or tier can be extracted and captured in the storage template. This ratio can then be used to assign the right number of hot spare disks based on total disks on any new storage system.

RAID configuration and layout: The choice of RAID configuration and layout is based on the intended usage of the storage system and whether the storage needs to be optimized for capacity, performance or resiliency; and thus become the three variables around which the choice of RAID layout pivots. For example, for a given resiliency, the RAID layout can be chosen to optimize capacity or optimize performance. Similarly, for a given performance, the RAID layout can be chosen to optimize for performance or optimize for resiliency.

Using storage templates for RAID configuration selection: If the storage template is used to configure a new system, then the above implementations can take into account the number of disks available in the new storage system and optimize the storage profile for best use of the new storage system. For example, the storage template may contain the RAID configuration policy that requires optimizing for resiliency, thereby selecting RAID 6. When the storage profile is created for a new storage system, the RAID layout can be selected based on the number of disk available in the new storage system so that there is minimum wastage or unused disk left in the storage system

Based on the total number of disks available per disk type, disk speed and disk capacity, the number of hot spare disk assigned and the applicable RAID layout selection, the algorithm calculates the number of parity groups that can be created and proceeds to select the appropriate number and location of disks for each parity group. The algorithm optimizes the selection of disk by selecting disks across as many storage trays as desired. The algorithm can do so to optimize for performance and resiliency.

Once the parity groups are created, the algorithm proceeds to create and initialize maximum sized, equal sized volumes (physical LDEVS) no greater than the allowed volume size for the given storage system. Further detail of the flow for parity group creation is provided below.

At 901, the management server identifies a total number of disks (storage devices) per disk type and speed from current array. At 902, the management server calculates the number of hot spare disks needed based on the disk type and speed. The management server can utilize settings from the storage profile to calculate the hot spare disks. At 903, the management server determines if the number of hot spares needed is more than the existing number of hot spares. If so (YES), then the flow proceeds to 904, otherwise (NO) the flow proceeds to 905. At 904, the management server assigns the hot spare disk, (e.g. one on each tray) on 1st “X” number of trays containing the appropriate disk that matches the disk type and speed. At 905, the management server filters out all the disks that are already in use or are selected for hot spares and cannot be allocated to parity groups. At 906, the management server groups available disks together that share same disk type, speed, and size per tray. At 907, for each disk type, speed, and size, the management server selects the RAID layout to optimize for capacity versus performance based on the specification provided by the storage profile.

At 908, the management server determines if the required number of parity groups have been created based on the storage profile. If so (YES), then the flow ends as indicated by the ‘B’ circle. Otherwise (NO), the flow proceeds to 909, wherein the management server selects different trays (e.g., up to four, depending on the desired implementation) to have disks available.

At 910, the management server determines if the trays have enough identical disks to form a parity group. If so (YES), then the flow proceeds to 912, otherwise (NO) the flow proceeds to 911.

At 911, the management server determines if all of the tray selections are exhausted. If so (YES) then the flow ends, otherwise (NO), the flow proceeds to 908.

At 912, the management server selects identical disks from the trays for each parity group. At 913, the management server creates the parity group and assigns the maximum possible equal sized number of LDEVS on the parity group. The flow proceeds to 908.

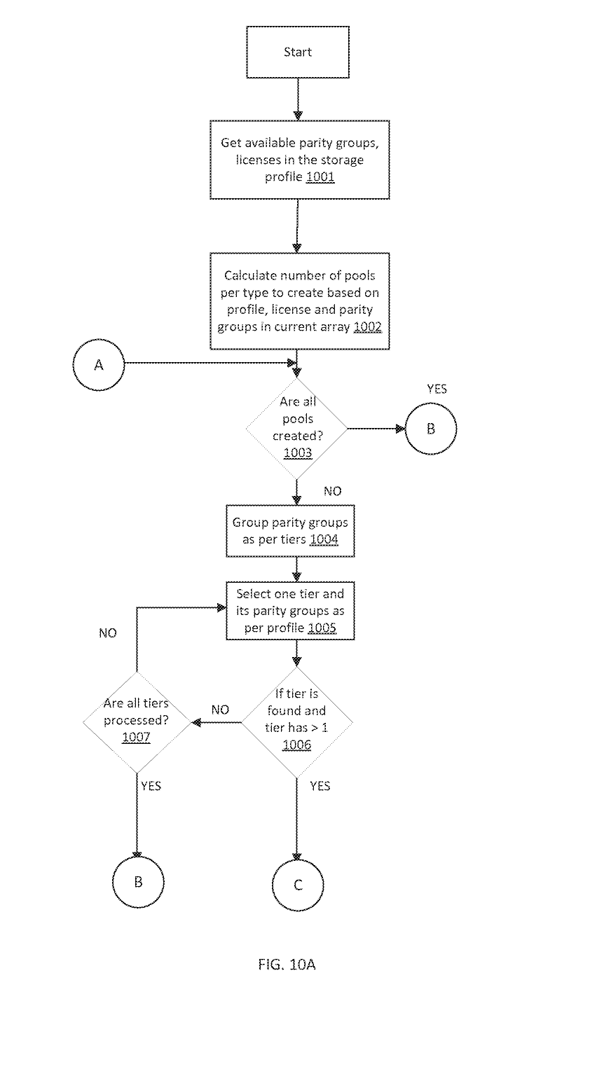

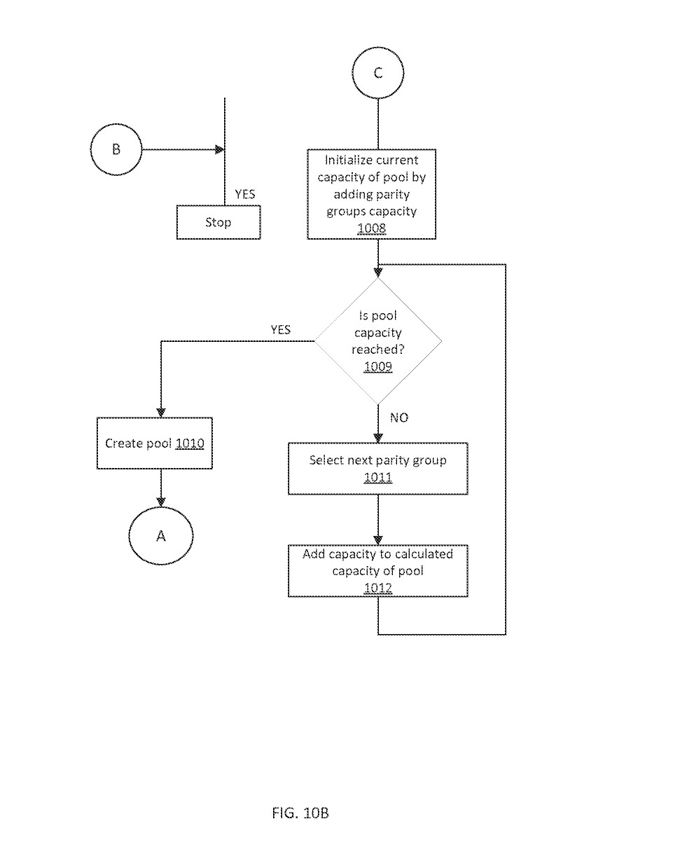

FIGS. 10A and 10B illustrate a pool creation flowchart, in accordance with an example implementation. Specifically, FIGS. 10A and 10B illustrate how pool sizes can be calculated and the right pool size can be selected and created based on the storage profile.

Example implementations provide for simplification and automating pool creation by detecting the existing parity groups available on a storage system and characterizing the tiers based on disk type, disk speed, and disk capacity. From such characterization, the example implementations further perform calculating and presenting the different pool types and sizes that can be created based on available parity group tiers.

Depending on the desired implementation, the administrator of the system may implement several desired practices. For example, the storage system can be configured to never mix parity groups of different disk type, disk capacity, disk speed, RAID type and RAID layout into the same dynamic provisioning (DP) pool. When allocating a Parity Group to a pool, example implementations may use the entire capacity of the parity group (i.e, all the LDEVs on a given parity group) and be configured such that a parity group cannot be split across multiple pools, unless there is a parity group on which a command device is created. In this case, the remaining capacity of the parity group can be allocated to a Pool.

In example implementations, a minimum of four parity groups can be used to create a pool with the exception of solid state drive (SSD) and flash module drives (FMD) where two parity groups may be acceptable. Further, for a tiered pool, continuous monitoring and tiering can be enabled by example implementations.

Based on the above policies, possible pool sizes can be calculated. Since the disk type, disk capacity, disk speed, RAID type and layout might not be mixed in a storage pool, calculating possible pool sizes proceeds as follows. First, example implementations identify all the Parity groups of the same (Disk type, Disk capacity, Disk speed, RAID type and layout) and their available capacity via usable LDEVs. Then, example implementations use combinations of these parity groups where four (two in the case of SSD & FMD) or more parity groups can be added together, to compute various possible pool sizes that can be created for the (Disk Type, Disk capacity, Disk speed, RAID type and layout)

Based on the storage system model, example implementations can determine the max pool size and discard any parity group combinations that add up to give a pool size that is greater than the maximum pool size for the storage system. Depending on the desired implementation, the list can be displayed in increasing order of the possible pool size.

For example, suppose that there are six parity groups of SAS 15K 300 GB RAID 6 6D+2. The parity group sizes are 2 TB each. The possible pool sizes using a minimum of four parity groups (PG) are: 8 TB, 10 TB, 12 TB.

To further simplify and automate storage pool creation, the example implementations focus on pre-defining performance tiers for storage pools. A pool tier can possibly support more than one disk type and speed, but when pool sizes for the tier are calculated, the parity groups of various disk type and disk speeds may not be mixed depending on the desired implementation. Instead, a union of individual sets of possible sizes is presented for pool creation. The use of predefined tiers is presented as an extension of the use of templates. Default tiers act as default pool templates that can be modified or overridden by creating new templates based on required policies.

For example, suppose that there is a pre-defined platinum tier to contain SSD and FMD disk types and possible pool sizes for SSD are 8 TB, 10 TB, 12 TB and that of FMD are 16 TB, 20 TB and 24 TB. The possible pool sizes of Platinum will therefore be 8 TB, 10 TB, 12 TB, 1 TB, 20 TB, 24 TB.

Example implementations also incorporate storage templates for the pool creation. If a storage template that contains rules for pool creation is used to configure a new storage system, then options can be presented to create specific types and sizes of pools before proceeding with the above described policies for actual pool creation. For example, if the storage template defines that 30% of a certain pool tier capacity be allocated for data protection, then when a storage profile is created for a new storage system, the management server will check if data protection pool creation requirements can be met. The example implementations check the available licenses on the new storage system to see if data protection can be supported, and determine the size of the data protection pool based on available parity groups on the new storage system.

At 1001, the management server obtains the available parity groups, licenses in the storage profile. At 1002, the management server calculates the number of pools per type to create based on the obtained profile, licenses in the storage profile and parity groups (e.g., in the storage profile) for the storage system. The calculation is based on the policies provided by the storage template that is incorporated into the storage profile.

However, in an example implementation, even if there is no pool creation policy and the tiering policy in the storage template, if the storage identity shows the storage system has licenses regarding pool creation (e.g. Internal copy license, Data tiering license) available, the licenses can be utilized to calculate the actual configuration based on the user preferred implementation (pre-defined value). For example, as an optional flow, if appropriate licenses (e.g., for internal copy/tier management) are available, the management server calculates number of pools the number of pools per type to create. Even if there is no pool creation policy in the storage template, if the storage system has a given license, the management server or the management computer can calculate actual configuration to use the given license based on the user defined preferred practices.

At 1003, the management server determines if all the pools are created. If so (YES) then the flow proceeds to ‘B’ where the process ends. Otherwise (NO), the flow proceeds to 1004, where the storage system groups parity groups as per tiers.

At 1005, the management server selects one tier and its parity groups in accordance with the storage profile. At 1006, the management server determines if the selected tier is found and that there are more than one tiers to be created. If so (YES), then the flow proceeds to 1008 as indicated by the ‘C’ circle. Otherwise (NO), the flow proceeds to 1007, wherein the management server determines if all the tiers are processed. If so (YES), then the flow proceeds to the ‘B’ circle where the process ends.

At 1008, the management server initializes the current capacity of the pool by adding the capacity from the parity groups. At 1009, the management server determines if pool capacity is reached. If so (YES), then the flow proceeds to 1010 to create the pool and then the flow proceeds to ‘B’ where the process ends. Otherwise (NO), the management server selects the next parity group 1011, and adds the capacity from the next parity group to the calculated capacity for the pool at 1012.

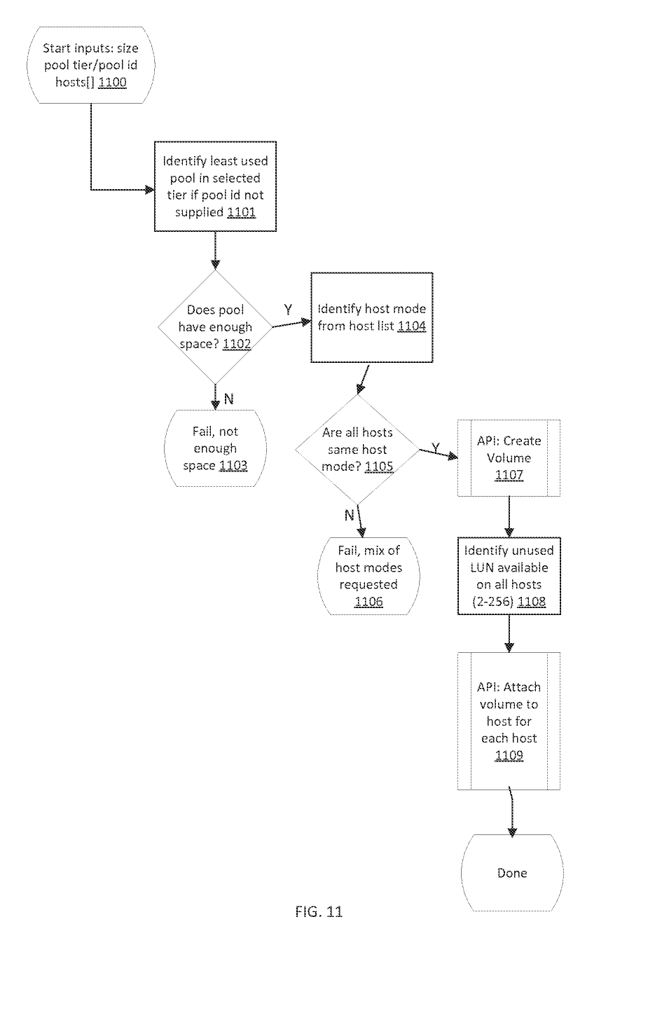

FIG. 11 illustrates a volume creation flowchart, in accordance with an example implementation. Specifically, FIG. 11 illustrates how a pool can be selected to create and attach a volume. The automatic creation and zoning of one or more volumes to a server is the last part for storage configuration. Specifically, the example implementations focus on the recommendation to create volumes on the storage system pools and remove the complexity of exposing the volumes to the servers over a fibre-channel network. Several policies are taken into consideration for facilitating the example implementations. For example, example implementations facilitate the detecting the current state of environment, including the server details (WWN, operating system type), fibre-channel switches, storage system port information and existing zone sets between any detected server and the storage system. Example implementations facilitate the selecting of the right storage pool from available pools of the requested tier, for the creation of volumes. The example implementations further facilitate the detecting of the world wide names for the storage array ports and selected server to which storage should be provisioned. Example implementations facilitate the detecting of the existing zone paths available between the storage system and the server and evaluating if any existing paths can be reused based on the host mode options. Example implementations further facilitate the selecting of the WWNs for the storage port and server to create zones, the creating of zones using the selected WWNs, based on zoning policies and templates and the setting up of host storage domains to optimize for workload or OS type of the server. For example implementations, the implementation of creating and attaching volumes to a server detects the existing zones available in a non-confined environment to determine if new zones should be created.

If the algorithm determines that new zones must be created, the zone creation algorithm also takes into account the existing utilization of the storage system ports and server WWNs to select the least utilized WWNs. The least utilized WWNs can be calculated by taking into account both capacity (count based) as well as performance.

At 1100, the management server initiates the process for volume creation based on starting inputs including the size of the pool tier, and pool id hosts. At 1101, the management server identifies the least used pool in selected tier if pool id not supplied. At 1102, the management server determines if the pool has enough space. If not (N), then the process ends and a failure indication is sent to the administrator to indicate that the pool has insufficient space as shown at 1103. At 1104, the management server identifies the host mode from the host list. At 1105, the management server determines if all of the hosts have the same host mode. If not (N), then the flow proceeds to 1106, where the process ends and the management server sends a failure indication to the administrator to indicate that a mix of host modes was requested.

At 1107, the management server activates the application programming interface (API) to create volumes. At 1108, the management server identifies the unused LUNs available on all hosts (e.g. 2-256). At 1109, the management server initiates the API to attach volumes to the host for each host.

In example implementations, the management server also utilizes storage templates for auto zoning. Example implementations conduct zone creation to be template driven such that the policies can be defined to determine the number of paths that are to be created between the server and the storage system volume. The policy can be enhanced to dictate the number of paths that must be available across each fabric in a multi fabric environment. The zoning policies can also be included as a part of storage profile that was created using an existing storage system. For the first storage system, where no prior template is being used, default policy suggested by this invention would be to create at least 2 paths per fabric and at least 2 fabrics. With both default policy as well as storage template driven policy, provisions can be added to modify or override the default policy via a new template for zone configuration.

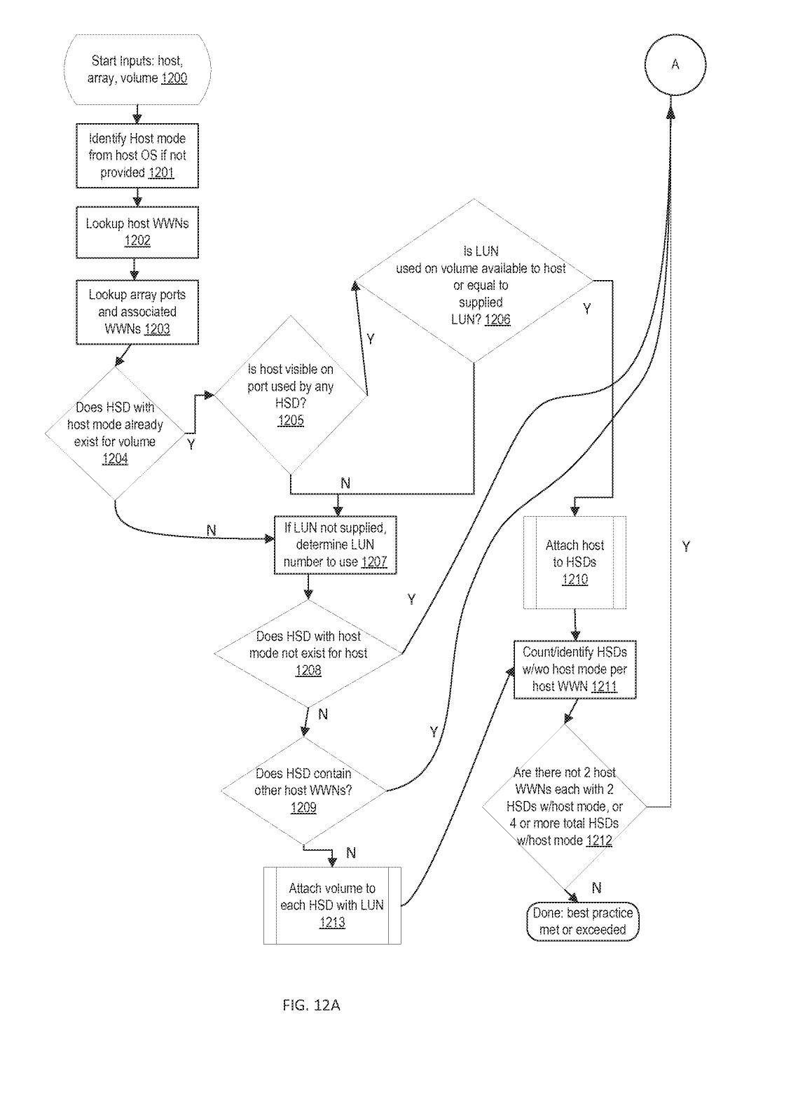

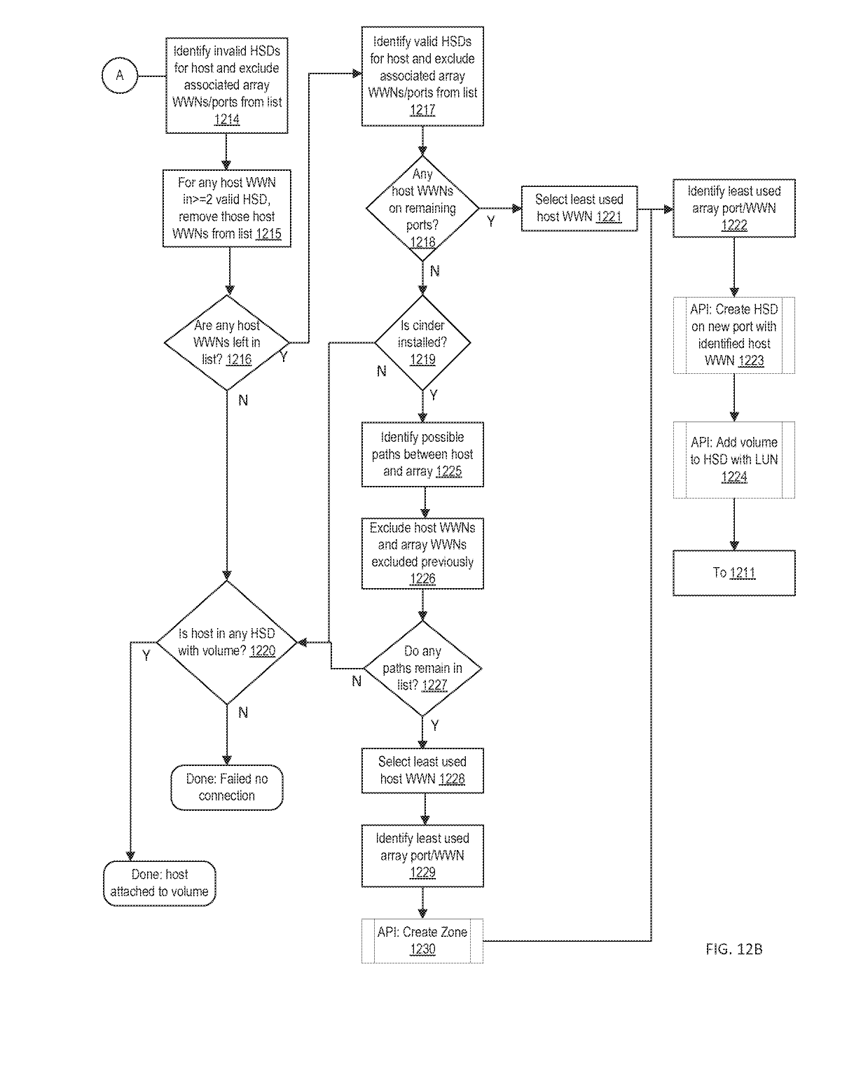

FIGS. 12A and 12B illustrate an attach volume and auto zoning flowchart, in accordance with an example implementation. Specifically, FIGS. 12A and 12B illustrate the sub process of the create volume API, and describes how auto zoning can be completed to attach a volume.

The flow diagram begins at 1200 as the management server receives as inputs the host, array and volume information. The management server may also take the host mode and the LUN as optional inputs, depending on the desired implementation. At 1201, the management server obtains the identify host mode from the host OS if not provided in 1200. At 1202, the management server conducts a lookup of host WWNs. At 1203, the management server conducts a lookup for array ports and associated WWNs. At 1204, the management server determines if the HSD (Host Storage Domain) with the host mode already exists for the specified volume. If so (Y), then the flow proceeds to 1205, otherwise (N) the flow proceeds to 1207.

At 1205, the management server determines if the host is visible on the port used by any of the HSD. If so (Y), then the flow proceeds to 1206, otherwise (N) the flow proceeds to 1207.

At 1206, the management server determines if the LUN used on the volume is available to host or equal to the supplied LUN. If so (Y) then the flow proceeds to 1210, otherwise (N) the flow proceeds to 1207.

At 1207, if the LUN is not supplied, the management server determines the LUN to use. At 1208, the management server determines if the HSD with host mode exists or not for the host. If so (Y) then the flow proceeds to 1214, otherwise (N) the flow proceeds to 1209.

At 1209, the management server determines if the HSD contains other host WWNs. If so (Y), then the flow proceeds to 1214, otherwise (N) the flow proceeds to 1213 to attach a volume to each HSD with a LUN and then proceeding to 1211.

At 1210, the management server attaches the host to HSDs in a manner to comply with the desired user implementations as described above, if possible. At 1211, the management server counts and identifies HSDs having or not having the host mode per host WWN. At 1212, the management server determines if there are not two host WWNs each with two HSDs having the host mode, or four or more total HSDs with the host mode as per the policies as implemented above. If so (Y) then the flow proceeds to 1214. Otherwise, (N) then the flow is completed and the example policies indicated above have been met or exceeded. The flow at 1212 can be adjusted according to the desired implementation with respect to the number of HSDs.

At 1213, the management server is configured to attach the volume to each HSD with a LUN and comply with the desired user implementations as described above, if possible.

At 1214, the management server is configured to identify invalid HSDs for the host and exclude associated array WWNs/ports from the list. At 1215, for any host WWN having more than two valid HSDs, the management server removes those host WWNs from list. The number of valid HSDs for this flow can be adjusted according to the desired implementation. At 1216, the management server determines if there are any host WWNs left in the list. If so (Y) then the flow proceeds to 1217, otherwise (N) the flow proceeds to 1220.

At 1218, the management server determines if the array can see any host WWNs on the remaining ports. If so (Y) then the flow proceeds to 1219, otherwise (N) the flow proceeds to 1221. At 1219, the management server determines if cinder is installed. If so (Y), then the flow proceeds to 1225, otherwise (N), the flow proceeds to 1220.

At 1220, the management server determines if there are any hosts in any HSD with the volume. If so (Y), then the management server completes the process and attaches the host to volume. Otherwise (N), the management server ends the process and sends a notification to the administrator indicating failure due to no connection.

At 1221, the management server is configured to select the least used host WWN. At 1222, the management server identifies the least used array port/WWN. At 1223, the API is invoked to create the HSD on the new port with the identified host WWN. At 1224, the API for adding the volume to the HSD with LUN is invoked, and the flow proceeds to 1211.

At 1225, the management server is configured to identify possible paths between host and array. At 1226, the management server excludes host WWNs and array WWNs excluded previously. At 1227, the management server determines if any of the paths remain in the list. If so (Y), then the flow proceeds to 1228, otherwise (N) the flow proceeds to 1220. At 1228, the management server selects the least used host WWN. At 1229, the management server identifies the least used array port/WWN. At 1230, the management server invokes the API to create a zone, wherein the flow proceeds to 1223.

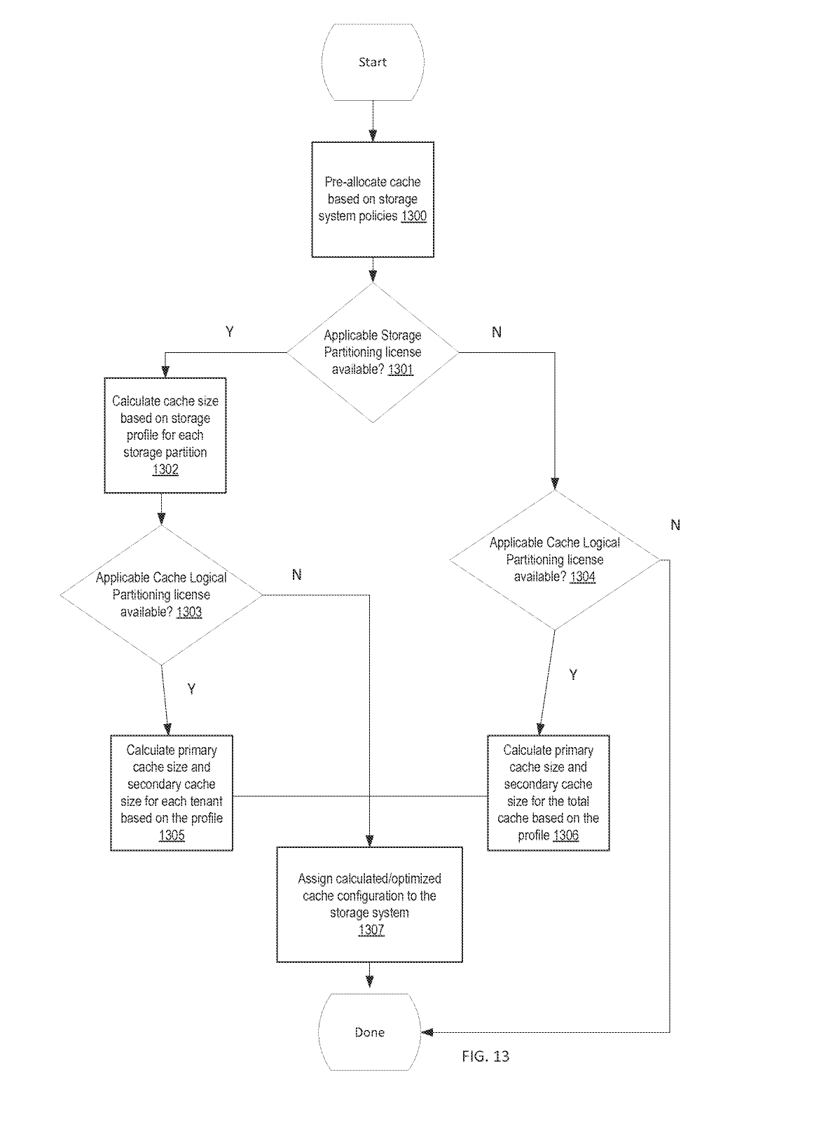

FIG. 13 illustrates a flow diagram for cache management, in accordance with an example implementation. The flow begins at 1300, wherein the management server first handles any special policies for the cache (e.g. dedicated cluster cache) that need to be resolved before allocation of the remaining portion of the cache.

At 1301, the management server determines if there are applicable storage partitioning licenses available for tenant creation. By the storage partitioning license, the storage system can provide multiple tenants (e.g., logically partitioned storage system) to multiple divisions. If so (Y), then the flow proceeds to 1302, wherein the percentage of cache or cache capacity to be used is calculated based on rules the storage profile for each tenant. As one example, the rule in the storage profile is “allocate 70% to division 1 and 30% to division 2”. Alternatively, if such information is not utilized in the storage profile, then the user preferred implementation values (e.g., pre-determined value) or values input from a user interface are utilized for each tenant. Otherwise (N), the flow proceeds to 1304.

At 1303, the management server determines if there are applicable cache logical partitioning licenses. If so (Y), then the flow proceeds to 1305, wherein the management server calculates the primary cache size or percentage of cache to be allocated as primary cache, and secondary cache size or percentage of cache to be allocated as secondary cache, “for each tenant” based on the storage profile. Alternatively, if such information is not utilized in the storage profile, then the user preferred implementation values or values input from a user interface are utilized for each tenant. Otherwise (N), the flow proceeds to 1307.

At 1304, the management server determines if there are applicable cache logical partitioning licenses. If so (Y), then the flow proceeds to 1306, wherein the management server calculates the primary cache size or percentage of cache to be allocated as primary cache, and secondary cache size or percentage of cache to be allocated as secondary cache, from the total cache based on the storage profile. Alternatively, if such information is not utilized in the storage profile, then the user preferred implementation values or values input from a user interface are utilized for each tenant. Then, the flow proceeds to 1307. Otherwise (N), the flow ends.

At 1307, after calculating the final configuration of cache memory stored in the storage profile, the management server assigns cache partitioning configuration to the storage system. Then, the flow ends.

Finally, some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for configuring a storage system, comprising:
creating a storage profile for the storage system by incorporating one or more configuration policies from a storage template associated with another storage system;
based on configuration information of the storage system and storage identity information of the storage system, deriving configuration settings of the storage system from the storage profile;
incorporating the derived configuration settings into the storage profile, and
applying the storage profile to configure the storage system.

2. The method of claim 1, wherein the deriving the configuration settings of the storage system from the storage profile comprises deriving parity group information for one or more storage devices of the storage system, wherein the one or more policies comprises parity group information associated with the another storage system;
wherein the applying the storage profile to configure the storage system comprises:
creating one or more parity groups based on the storage profile from a selection of a plurality of storage devices of the storage system for each of the one or more parity groups, wherein the selection of the plurality of storage devices is based on disk type.

3. The method of claim 1, wherein the deriving configuration settings of the storage system from the storage profile comprises deriving pool creation information for one or more storage devices of the storage system, wherein the one or more policies comprises pool creation information associated with the another storage system;
wherein the applying the storage profile to configure the storage system comprises:
grouping each parity group of the storage system based on storage tier;
initializing each pool for the storage system with capacity from the each parity group; and
adding capacity from the each parity group until pool capacity according to the pool creation information is met to create the each pool.

4. The method of claim 1, wherein the deriving the configuration settings of the storage system from the storage profile comprises deriving zoning information for one or more storage devices of the storage system, wherein the one or more policies comprises zoning information associated with the another storage system;
wherein the applying the storage profile to configure the storage system comprises:
creating one or more zones based on selection of pathways between one or more hosts and one or more storage volumes formed from one or more storage devices of the storage system.

5. The method of claim 1, wherein the deriving configuration settings of the storage system from the storage profile comprises deriving caching information for one or more storage devices of the storage system, wherein the one or more policies comprises caching information associated with the another storage system;
wherein the applying the storage profile to configure the storage system comprises:
calculating, from the caching information, a first capacity of a cache of the storage system to be utilized as primary cache and a second capacity of the cache of the storage system to be utilized as secondary cache.

6. The method of claim 1, wherein the storage identity information comprises information indicative of available licenses for the storage system; wherein the applying the storage profile to configure the storage system is based on the information indicative of the available licenses for the storage system.

7. The method of claim 1, wherein the creating a storage profile for the storage system by incorporating one or more configuration policies from the storage template associated with another storage system comprises:
extracting parity group information from the storage template associated with the another storage system;
extracting pool creation information from the storage template associated with the another storage system;
extracting zoning information from the storage template associated with the another storage system;
extracting caching information from the storage template associated with the another storage system;
wherein the deriving configuration settings of the storage system from the storage profile comprises:
calculating a number of parity groups for each pool from the extracted parity group information and available storage devices of the storage system, and
calculating zoning policies for the storage system from the extracted zoning information and available storage devices of the storage system.

8. A management computer communicatively coupled to a storage system, comprising:
a memory configured to store a storage template associated with another storage system; and
a processor, configured to:
create a storage profile for the storage system by incorporating one or more configuration policies from the storage template associated with the another storage system;
based on configuration information of the storage system and storage identity information of the storage system, derive configuration settings of the storage system from the storage profile;
incorporate the derived configuration settings into the storage profile, and
apply the storage profile to configure the storage system.

9. The management computer of claim 7, wherein the processor is configured to derive the configuration settings of the storage system from the storage profile by deriving parity group information for one or more storage devices of the storage system, wherein the one or more policies comprises parity group information associated with the another storage system;
wherein the processor is configured to apply the storage profile to configure the storage system by:
creating one or more parity groups based on the storage profile from a selection of a plurality of storage devices of the storage system for each of the one or more parity groups, wherein the selection of the plurality of storage devices is based on disk type.

10. The management computer of claim 7, wherein the processor is configured to derive configuration settings of the storage system from the storage profile by deriving pool creation information for one or more storage devices of the storage system, wherein the one or more policies comprises pool creation information associated with the another storage system;
wherein the processor is configured to apply the storage profile to configure the storage system by:
grouping each parity group of the storage system based on storage tier;
initializing each pool for the storage system with capacity from the each parity group; and
adding capacity from the each parity group until pool capacity according to the pool creation information is met to create the each pool.

11. The management computer of claim 7, wherein the processor is configured to derive the configuration settings of the storage system from the storage profile by deriving zoning information for one or more storage devices of the storage system, wherein the one or more policies comprises zoning information associated with the another storage system;
wherein the processor is configured to apply the storage profile to configure the storage system by:
creating one or more zones based on selection of pathways between one or more hosts and one or more storage volumes formed from one or more storage devices of the storage system.

12. The management computer of claim 7, wherein the processor is configured to derive configuration settings of the storage system from the storage profile by deriving caching information for one or more storage devices of the storage system, wherein the one or more policies comprises caching information associated with the another storage system;
wherein the processor is configured to apply the storage profile to configure the storage system by:
calculating, from the caching information, a first capacity of a cache of the storage system to be utilized as primary cache and a second capacity of the cache of the storage system to be utilized as secondary cache.

13. The management computer of claim 7, wherein the storage identity information comprises information indicative of available licenses for the storage system; wherein the processor is configured to apply the storage profile to configure the storage system based on the information indicative of the available licenses for the storage system.

14. The management computer of claim 7, wherein the processor is configured to create a storage profile for the storage system by incorporating one or more configuration policies from the storage template associated with another storage system by:
extracting parity group information from the storage template associated with the another storage system;
extracting pool creation information from the storage template associated with the another storage system;
extracting zoning information from the storage template associated with the another storage system; and
extracting caching information from the storage template associated with the another storage system;
wherein the processor is configured to derive configuration settings of the storage system from the storage profile by:
calculating a number of parity groups for each pool from the extracted parity group information and available storage devices of the storage system, and
calculating zoning policies for the storage system from the extracted zoning information and available storage devices of the storage system.

15. A computer program for configuring a storage system, having instructions for executing a process, the instructions comprising:
creating a storage profile for the storage system by incorporating one or more configuration policies from a storage template associated with another storage system;
based on configuration information of the storage system and storage identity information of the storage system, deriving configuration settings of the storage system from the storage profile;
incorporating the derived configuration settings into the storage profile, and
applying the storage profile to configure the storage system.
